(19) United States
(12) Patent Application Publication
(10) Pub. No.: US 2007/0241981 A1
(43) Pub. Date: Oct. 18, 2007

(54) Wideband Antenna with Omni-Directional Radiation

(76) Inventors: Franck Thudor, Rennes (FR); Philippe Chambelin, Chateaugiron (FR); Emeric Gueguen, Rennes (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/628,884

(22) PCT Filed: Jun. 3, 2005
(86) PCT No.: PCT/EP05/52555

§ 371 Date: Dec. 8, 2006

(30) Foreign Application Priority Data
Jun. 9, 2004 (FR) 0451148

(51) Int. Cl. H01Q 9/16

(52) U.S. Cl. 343/793

(57) ABSTRACT

The present invention relates to a wideband antenna with omni-directional radiation comprising two conductive arms placed on a substrate one of the two arms, called second arm, is supplied by a shielded line by using the other arm, called first arm.

The present invention relates to a wideband antenna with omni-directional radiation intended to receive and/or transmit electromagnetic signals that can be used in the wireless high bit rate communications field, more particularly for wideband pulse regime transmissions of the type UWB (Ultra Wideband). Such communication is, for example, of type WLAN, WPAN, WBAN.

In pulse regime, the information is sent in a pulse train, for example very short pulses in the order of the nanosecond. This results in a wideband of frequencies.

Ultra Wideband transmissions, originally reserved for military applications, are gradually being introduced into the domain of civil telecommunications. Hence, the frequency band [3.1; 10.6] GHz was recently adopted by the American FCC body to enable the development of UWB communications applications for which the standard is currently being constructed.

Many applications require isotropic antennas, that is with a symmetry of revolution in the radiation pattern. This is particularly the case for applications in which portable products are used, which theoretically have no special fixed position and which must communicate via a UWB wireless link with a point of access. Here, for example products of the type Video Lyra, mobile PCs, etc. are involved. This is also the case for fixed point-to-point applications for which a permanent link is required to be provided in order to provide a certain quality of (QoS). Indeed, person(s) moving can break the beam between two highly directive antennas and it is preferable to use omni-directional antennas for transmission and/or reception. Here, for example, a video server communicating with a high definition television receiver is involved.

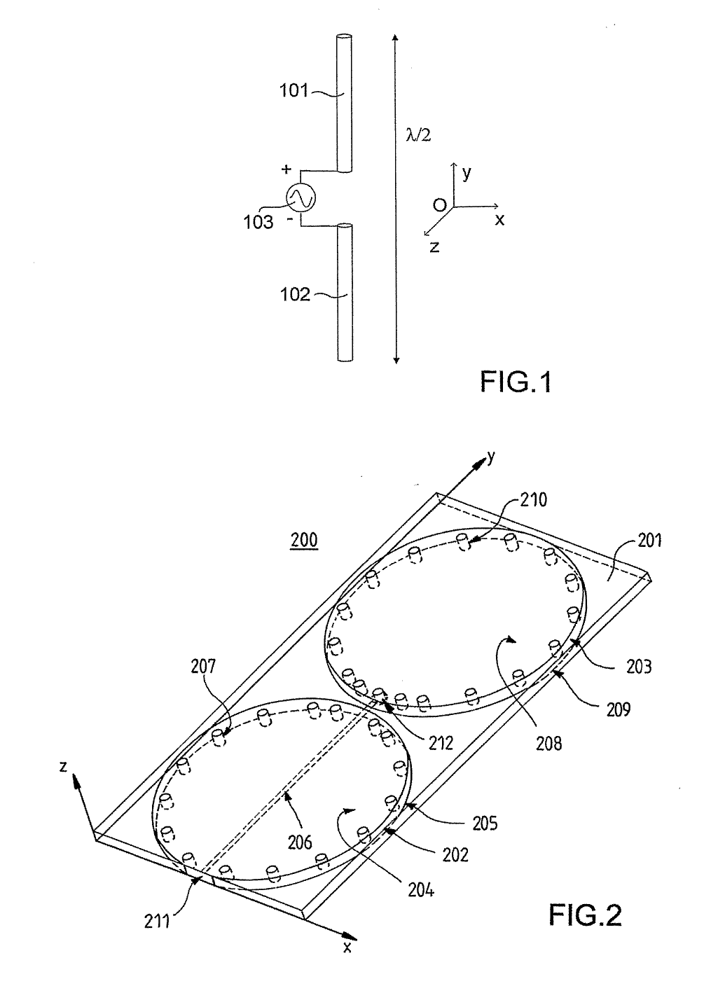

One of the most known omni-directional antennas is the dipole. As shown on FIG. 1, it comprises two identical arms 101 and 102 of length λ/4 placed opposite each other and differentially supplied by a generator 103. This type of radiating element has been thoroughly studied and used from the beginnings of electromagnetism, mainly for its simplicity of implementation but especially for the simplicity of the mathematic expressions governing its electromagnetic mechanism. Chapter 5 of “Antennas” by J. D. Kraus, Second Edition, Mac Graw Hill, 1988, contains the mathematic expressions explaining the mechanism of this type of radiating element. In particular, the long distance radiated field is maximum in the midperpendicular plane of the dipole (plane xOz in FIG. 1), and its theoretical impedance is around 75 Ω. It was originally used in wireline technology for diverse applications such as amateur radio, UHF reception and even more recently in the wireless networks of the WLAN type. Since the advent of printed circuits, its realization has been simplified still further, the antenna now becoming an integral part of the circuit.

The problem related to this type of radiating element is on the one hand its small bandwidth and on the other its supply, which generally disturbs the symmetry of the structure. This leads to a disymmetrization of the near fields and results in a degradation of the far field pattern. Consequently, this is no longer as omni-directional.

Wideband structures based on the association of two conductive circles supplied differentially are already known. The patent U.S. Pat. No. 6,642,903 describes such a structure. A complex structure is proposed for supplying conductive circles so as to enable the radiating element to present an isotropic radiation pattern.

The present invention proposes a wideband antenna with omni-directional radiation having a simple integrated supply that does not disturb the radiation pattern. Moreover, this antenna enables pulse regime wireless communication.

The present invention relates to a wideband antenna with omni-directional radiation comprising two conductive arms placed on a substrate, characterized in that one of the two arms, called second arm, is supplied by a shielded line via the other arm, called first arm.

Indeed, the first arm being realized in a conductive material, it allows, having a matched structure, to the shielding of a feeder line to be realized. The shielding realizes an electromagnetic isolation of the field lines generated by the line. Hence, the antenna radiation is not disturbed by the supply.

In one embodiment, both arms are placed on a substrate with two faces, at least the first arm comprising two conductive elements of identical geometry placed opposite on the two faces of the substrate, the second arm is supplied by a line placed in the substrate under the first arm.

Indeed, the line passing between the two conductive elements is thus “hidden” with respect to the antenna. Hence, any spurious current induced in the arms is prevented. This provides symmetry at the level of the near and far fields and therefore omni-directional patterns in the midperpendicular plane passing between the arms.

According to one realization of the invention, the two conductive elements are linked by holes made to pass through the substrate and filled with conductive material.

This characteristic enables the leaks generated by the feeder line in the form of a surface wave in the substrate.

According to one realization of the invention, the holes are made at the peripheral area of the conductive elements.

This characteristic ensures that both parts of the conductive elements, which are opposite each other, have the same potential.

In one embodiment, the second arm comprising two conductive elements of identical geometry placed opposite on the two faces of the substrate.

The manufacture of such a second arm is obtained simultaneously with the manufacture of the first arm and procures a symmetrical structure with respect to the midperpendicular plane at the antenna. Naturally, conductive holes, particularly in the peripheral area of the conductive elements can also be made on the second arm.

In one embodiment, at least one of the arms includes a circular conductive element.

The circular conductive elements are known in the prior art to enable wideband antennas to be realized. Other geometries, particularly elliptical, can be used as shown in FIG. 9.

In one advantageous embodiment, a circuit is integrated under at least one arm.

Other characteristics and advantages of the present invention will emerge on reading the description of different embodiments, the description being made with reference to the annexed drawings wherein:

FIG. 1 is a conceptual schema of a dipole.

FIG. 2 is a perspective view of an antenna according to one embodiment of the present invention.

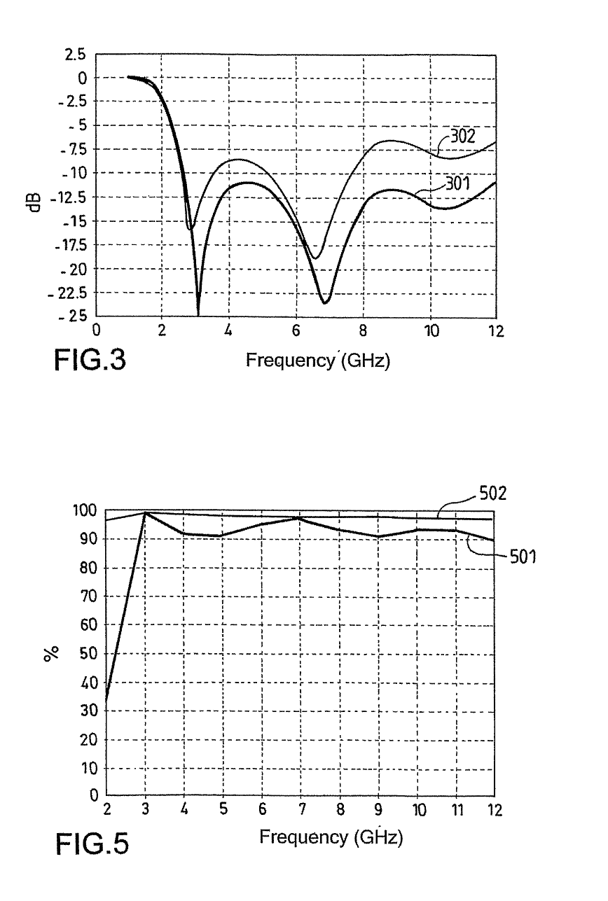

FIG. 3 shows a curve giving the reflection coefficient as function of the frequency of the signal supplying the antenna shown in FIG. 2.

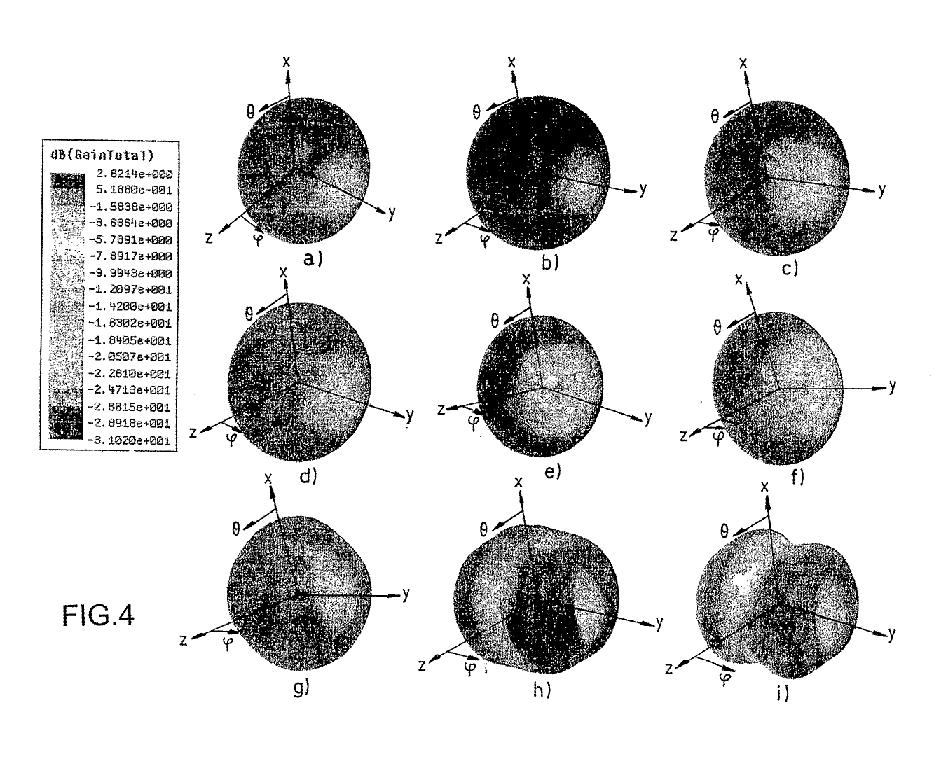

FIG. 4a to FIG. 4i show the 3D radiation patterns of the antenna of FIG. 3.

FIG. 5 shows two curves giving the efficiency of the antenna shown in FIG. 2.

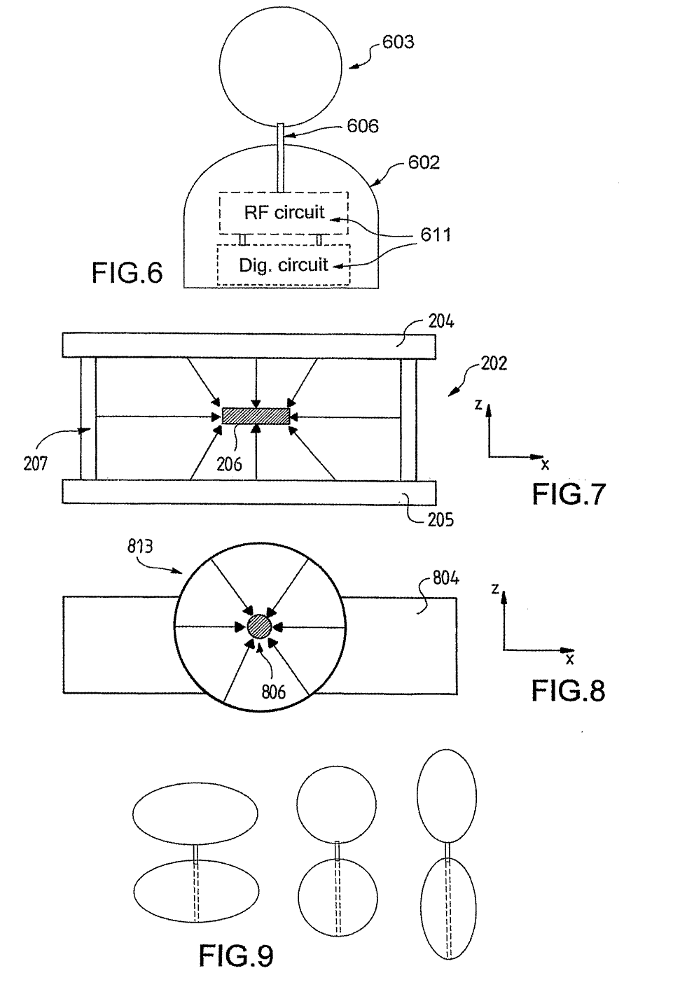

FIG. 6 is a diagrammatic top view of an antenna according to one advantageous embodiment of the invention.

FIG. 7 shows a section according to the plane (xz) passing through the centre of the conductive element 202 of the antenna shown in FIG. 2.

FIG. 8 presents a section according to the equivalent of the plane (xz) passing through the centre of a conductive element of an antenna according to one variant of the invention.

FIG. 9 gives variants of geometries for one antenna according to the invention.

With reference to FIGS. 2 to 5, an embodiment of a wideband antenna with omni-directional radiation compliant with the present invention will first be described.

As shown in FIG. 2, the antenna comprises two arms 202 and 203 that constitute a dipole. These arms, respectively 202 and 203, each include two circular conductive elements, respectively 204 and 205 and 208 and 209. The circular conductive elements are placed opposite in pairs on a substrate 201. For example, they can be engraved, laid, glued, printed on the substrate 201. The conductive elements are realized with metal materials. For example, they can also be made of copper. One can also use a plastic material (like “dibbon”) with a metallization on its faces (with an aluminium sheet, for example) or metallized foam.

The substrate 201 can be realized in various flexible or rigid materials. For example, it can be constituted by a flexible or rigid printed circuit plate or by any other dielectric material: a glass plate, plastic plate, etc. A flat antenna and having advantageous properties is therefore easily realized according to the invention.

According to the embodiment of FIG. 2, the conductive elements are connected by metallized holes, for example 207 and 210.

The supply of the dipole is realized by a first contact 211 at the level of the first arm 202 and by a second contact 212 at the level of the second arm 203. The second contact 212 is connected to a generator using a buried line 206 passing under the first arm 202. The generator normally belongs to an RF circuit from which the energy is brought to the antenna. The line 206 is therefore a strip line. This enables this line to be hidden with respect to the antenna. This can also prevent any spurious current from being induced in the arms. The operation of the antenna is therefore unaffected by the supply. This results in a symmetry at the level of the near and far fields and therefore by omni-directional radiation patterns in the midperpendicular plane. The supply that, in the prior art, breaks the revolution symmetry of the radiation patterns is thus rendered symmetrical according to the invention.

FIG. 7 shows a section according to the plane (xz) passing through the centre of the conductive element 202 of the antenna shown in FIG. 2. It is seen that all of the conductive elements 204, 205 and metallized holes 207 diagrammatically shown, represent a first conductor, and the feeder line 206, representing a second conductor, forms a strip line. The electric field lines between the two conductors are shown by arrows in this figure. The dielectric environment in which these fields propagate is uniform. The strip line is a transmission line propagating a mode called TEM (Transverse Electric and Magnetic) for which the electric and magnetic fields only have one transverse component (i.e. in the cutting plane). The line is therefore shielded as the electric and magnetic waves are guided and do not radiate. They therefore do not disturb the radiation pattern.

To simulate the results obtained, an antenna as shown in FIG. 2 was realized by using two arms each one comprising two circular conductive elements of diameter 19.5 mm engraved opposite each other on the two faces of a substrate of type FR4 of relative permittivity εᵣ=4.4 and height h=1 mm. These arms are separated by a distance d=1 mm. The facing conductive elements are connected in pairs by metallized holes. The width of the line 206 is 0.4 mm. This line passes “inside” the first arm and terminates in a metallized via that connects it to the second arm. This structure was simulated using the electromagnetic software HFSS (Ansoft) and IE3D (Zeland). The results of the simulation are given in FIGS. 3 to 5.

As shown in the curve 301 in FIG. 3, a direct matching for an impedance of 50 Ω is obtained. This impedance is lower than for the curve 302 realized for a dipole including two arms each one comprising a conductive element on a singe face of the substrate. This reduction in impedance comes from placing in parallel the impedances caused by the thickening of the metallizations. As shown by the curve 301 in FIG. 3, this property enables an antenna to be obtained having a matching lower than −10 dB on a very large bandwidth as the band 2.65-12 GHz is covered.

The largest dimension of the antenna is therefore (19.5*2+1)=40 mm, namely 0.35λ at 2.65 GHz. One of the advantages of the antenna according to the invention, observed on the curve 301, is therefore that the low frequency is lower than for a dipole including two arms each one comprising a conductive element on a single face of the substrate for a matching of 75 Ω. A frequency offset of −8.6% is obtained (passing from 2.9 GHz to 2.65 GHz).

Another advantage concerns the 50 Ω direct matching as no 75 Ω to 50 Ω impedance transformer is required between the antenna and the RF feeder circuits. The line drops are therefore limited. This is all the more advantageous as this type of transformer is difficult to realize on such a bandwidth with creating frequency distortions.

FIG. 4 shows the radiation patterns at different frequencies 2.65 GHz (4a), 3 GHz (4b), 4 GHz (4c), 5 GHz (4d), 6 GHz (4e), 7 GHz (4f), 8 GHz (4g), 9 GHz (4h), 10 GHz (4i). The omni-directional nature of these patterns is verified for a very large frequency band. For the upper frequencies of the band (f>9 GHz), a ripple in the pattern of around 8 dB is observed in the azimuth plane. This ripple will very slightly degrade the form of the signal emitted, only the high frequency (rapid variations of the signal) components that will not be emitted isotropically in the azimuthal plane. To compensate for this ripple, It is sufficient to redimension the entire structure slightly higher in frequency by reducing these dimensions by a factor 3.1 GHz/2.65 GHz=1.17. The ripple that appears at 9 GHz will then appear at 1.17×9=10.5 GHz, that is almost outside of the useful band.

The following table shows that the value of the gain is almost constant throughout the frequency band.

TABLE 1

| Frequency (GHz) | Gain (dBi) |
|---|---|
| 2.65 | 2.3 |
| 3 | 2.2 |
| 4 | 2.5 |
| 5 | 2.9 |
| 6 | 3.7 |
| 7 | 3.7 |
| 8 | 2.5 |
| 9 | 2.7 |
| 10 | 2.6 |
| 11 | 2.8 |

FIG. 5 shows the efficiency of illumination 502 of the dipole and the global efficiency 501 of the antenna. This efficiency is greater than 91% for the entire 3.1-10.6 GHz band. This point is particularly interesting for the UWB technology, where minimum power can be transmitted without using any amplification stage.

The invention responds particularly well to the time constraints imposed by pulse systems owing to its geometric form and its integrated feeder system. Moreover, this antenna is matched to an impedance of 50 Ω, which is the standard of impedance for the radiofrequency circuits.

With reference to FIG. 6, another advantageous embodiment of the present invention will now be described. This figure represents a dipole having non-symmetric arms with respect to the azimuthal plan. Indeed, according to the invention, the two arms can have different forms. In particular, according to FIG. 6, the first arm 602 under which the feeder line 606 of the second arm 603 passes is larger and serves as a ground plane for one or more circuit(s) 611 located behind the antenna. Such circuits 611 can for example be an RF circuit and/or a digital circuit.

As shown by the simulation results, an antenna according to the invention has the following advantages:
Omni-directional character of the radiation pattern in an azimuthal plane on a wide frequency band.
Good level of matching for a wide frequency band.
Ease of integrating this type of antenna in consumer products owing to—a flat profile.
Integration of the radiofrequency circuit on the same board as the antenna (printed circuit technology).
Low-cost solution as it is in printed circuit technology on any low-cost substrate.
Structure of small dimensions: the largest dimension is 0.35λ at the lowest frequency.
   The invention is not limited to the embodiments described and those skilled in the art will recognise the existence of diverse variants of embodiments as for example the realization of a shielded line realized by using a coaxial cable integral with the first arm. In this case, the coaxial cable is soldered to a conductive element placed on one face of a substrate. Such a conductive element is for example similar to that of 204 represented in FIG. 2. Advantageously, as shown in FIG. 8, the coaxial cable 813 is soldered along the diameter perpendicular to the azimuthal plane (xz) and belonging to the conductive element 804.

Moreover, as shown in FIG. 9, the conductive elements can be not only circular (as in FIG. 2), but also elliptical in shape with a vertical or horizontal main axis.

1. A wideband antenna with omni-directional radiation comprising two conductive arms placed on a substrate, wherein one of the two arms, called second arm, is supplied by a shielded line by using the other arm, called the first arm.

2. The antenna according to claim 1, in which the two arms being placed on a substrate presenting two faces, at least the first arm comprises two conductive elements of identical geometry placed opposite each other on the two faces of the substrate and the second arm is supplied by a line placed in the substrate under the first arm.

3. The antenna according to claim 2, wherein the two conductive elements are connected by holes passing through the substrate and filled with conductive material.

4. The antenna according to claim 3, wherein the holes are made on the periphery of the conductive elements.

5. The antenna according to claim 2, wherein the second arm comprises two conductive elements of identical geometry placed opposite each other on the two faces of the substrate.

6. The antenna according to claim 2, wherein a circuit is integrated in at least one arm.

7. The antenna according to claim 1, wherein at least one of the arms includes a circular conductive element.
